(19) United States
(12) Patent Application Publication
(10) Pub. No.: US 2017/0297012 A1
(43) Pub. Date: Oct. 19, 2017

(54) COBALT-BASED CATALYST AND METHODS RELATED THERETO

(71) Applicant: SABIC GLOBAL TECHNOLOGIES B.V., Bergen op Zoom (NL)

(72) Inventors: Talal Khaled Al-Shammari, Riyadh (SA); Abdulkarim Al-Mutairi, Riyadh (SA); Khalid Karim, Riyadh (SA); Asad Ahamad Khan, Riyadh (SA); Jayen Barochia, Riyadh (SA)

(21) Appl. No.: 15/513,445

(22) PCT Filed: Sep. 18, 2015
(86) PCT No.: PCT/IB2015/057209

§ 371 Date: Mar. 22, 2017

Related U.S. Application Data
(60) Provisional application No. 62/190,523, filed on Jul. 9, 2015.
(60) Provisional application No. 62/054,072, filed on Sep. 23, 2014.

(51) Int. Cl. B01J 37/18; B01J 23/75

(52) U.S. Cl. CPC B01J 37/18; B01J 23/75

(57) ABSTRACT

The present disclosures and inventions relate to methods of reducing and activating a cobalt catalyst by contacting an at least partially oxidized cobalt catalyst with a reducing gas, such as a first, second, and/or third reducing gas, at a temperature from 220 ° C. to 270 ° C. for at least 8 or 50 hours depending on the reducing gas, thereby reducing and activating the cobalt catalyst.

### CROSS-REFERENCE TO RELATED APPLICATIONS

This Application claims the benefit of U.S. Provisional Application No. 62/054,072, filed on Sep. 23, 2014, and U.S. Provisional Application No. 62/190,523, filed on Jul. 9, 2015, which both are incorporated herein by reference in their entirety.

### FIELD OF THE INVENTIONS

The compositions and methods disclosed herein relate to cobalt catalysts and the preparation and use of the cobalt catalysts for the conversion of hydrogen/carbon monoxide mixtures (syngas) to hydrocarbons.

### BACKGROUND

Syngas (mixtures of hydrogen and carbon monoxide) can be readily produced from either coal or methane (natural gas) by methods well known in the art and widely commercially practiced around the world. A number of well-known industrial processes use syngas for producing various oxygenated organic chemicals. The Fischer-Tropsch catalytic process for catalytically producing hydrocarbons from syngas was initially discovered and developed in the 1920's, and was used in South Africa for many years to produce gasoline range hydrocarbons as automotive fuels. Thus, the production of catalysts used in the Fischer-Tropsch process, such as cobalt catalysts, is an important process related to syngas conversion. Methods that reduce the cost of the production of high activity cobalt catalysts are desired.

Accordingly, disclosed herein are cobalt catalysts and the preparation and use of the cobalt catalysts for the conversion of syngas to hydrocarbons.

### SUMMARY OF THE INVENTION

Disclosed herein is a method of reducing and activating a cobalt catalyst comprising the step of: a) contacting an at least partially oxidized cobalt catalyst with a first reducing gas at a temperature from 220° C. to 270° C. for at least 50 hours, and/or b) contacting an at least partially oxidized cobalt catalyst with a second reducing gas consisting essentially of H₂ at a temperature from 220° C. to 270° C. for at least 8 hours, thereby reducing and activating the cobalt catalyst.

Also disclosed herein is a method of reducing and activating a cobalt catalyst comprising the step of: a) contacting an at least partially oxidized cobalt catalyst with a third reducing gas at a temperature from 220° C. to 270° C. for at least 8 hours, wherein the third reducing gas comprises an amount of H₂ sufficient to reduce and activate the cobalt catalyst, thereby reducing and activating the cobalt catalyst.

Also disclosed herein is a method of reducing and activating a cobalt catalyst consisting essentially of the step of: a) contacting an at least partially oxidized cobalt catalyst with a first reducing gas at a temperature from 220° C. to 270° C. for at least 50 hours, thereby reducing and activating the cobalt catalyst.

Also disclosed herein is a method of reducing and activating a cobalt catalyst consisting essentially of the step of: a) contacting an at least partially oxidized cobalt catalyst with a second reducing gas consisting essentially of H₂ at a temperature from 220° C. to 270° C. for at least 8 hours, thereby reducing and activating the cobalt catalyst.

Also disclosed herein is a catalyst produced by the methods disclosed herein.

Also disclosed herein is a method of producing hydrocarbons comprising contacting syngas with a cobalt catalyst disclosed herein, thereby producing hydrocarbons

Additional advantages will be set forth in part in the description which follows, and in part will be obvious from the description, or can be learned by practice of the aspects described below. The advantages described below will be realized and attained by means of the chemical compositions, methods, and combinations thereof particularly pointed out in the appended claims. It is to be understood that both the foregoing general description and the following detailed description are exemplary and explanatory only and are not restrictive.

### DESCRIPTION OF THE FIGURES

The accompanying figures, which are incorporated in and constitute a part of this specification, illustrate several aspects, and together with the description, serve to explain the principles of the invention.

FIG. 1 shows the temperature-programmed reduction (TPR) data of Co₃O₄.

FIG. 2 shows the CO and H₂ conversion on a cobalt catalyst that has been reduced at 250° C. for about 65 hours.

FIG. 3 shows the performance of a cobalt catalyst that was reduced at 350° C. for 16 hours (1) and a cobalt catalyst that was reduced at 250° C. for 65 hours (2).

FIG. 4 shows the CO conversion on a cobalt catalyst that has been reduced at 250° C. for about 16 hours in 100% H₂.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Disclosed herein are materials, compounds, compositions, and components that can be used for, can be used in conjunction with, can be used in preparation for, or are products of the disclosed method and compositions. It is to be understood that when combinations, subsets, interactions, groups, etc. of these materials are disclosed, that while specific reference of each various individual and collective combinations and permutation of these compounds cannot be explicitly disclosed, each is specifically contemplated and described herein. For example, if a catalyst component is disclosed and discussed, and a number of alternative solid state forms of that component are discussed, each and every combination and permutation of the catalyst component and the solid state forms that are possible are specifically contemplated unless specifically indicated to the contrary. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

1. Definitions

In this specification and in the claims which follow, reference will be made to a number of terms which shall be defined to have the following meanings:

It must be noted that, as used in the specification and the appended claims, the singular forms “a,” “an” and “the” include plural referents unless the context clearly dictates otherwise. Thus, for example, reference to “a catalyst” includes mixtures of catalysts.

Ranges can be expressed herein as from one particular value, and/or to another particular value. When such a range is expressed, another aspect includes from the one particular value and/or to the other particular value. Similarly, when values are expressed as approximations, by use of the antecedent “,” it will be understood that the particular value forms another aspect. It will be further understood that the endpoints of each of the ranges are significant both in relation to the other endpoint, and independently of the other endpoint.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight of component Y, X and Y are present at a weight ratio of 2:5, and are present in such a ratio regardless of whether additional components are contained in the compound.

A weight percent of a component, unless specifically stated to the contrary, is based on the total weight of the formulation or composition in which the component is included.

As used herein, the terms space time yield (“STY”) refers to the tons or kg of product that is produced per unit time per volume of catalyst.

2. Methods for Preparing a Catalyst

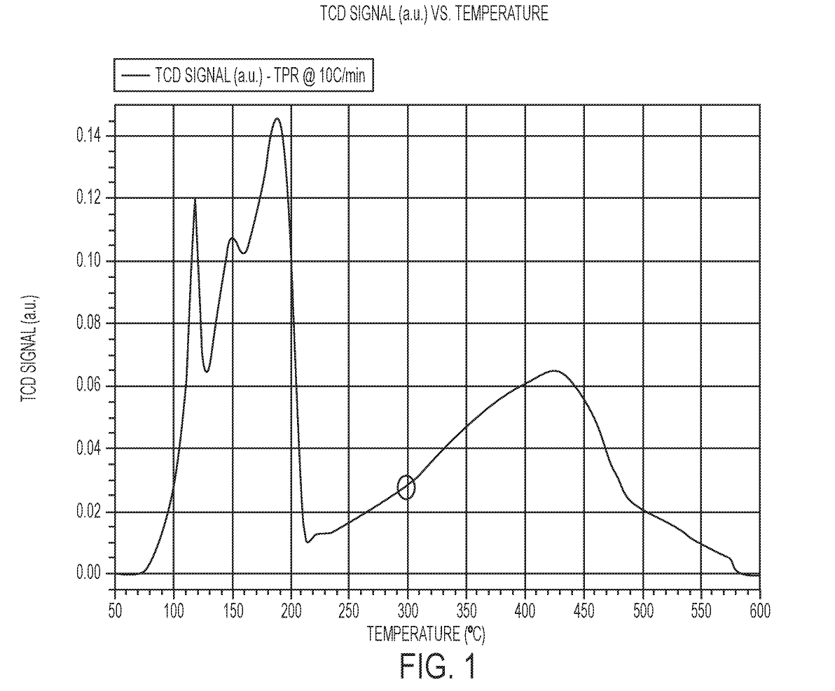

Temperature-programmed reduction (TPR) is a common technique used to find the most efficient reduction conditions for an oxidized form of a catalyst, i.e. oxidized cobalt, such as Co₃O₄. Literature and the TRP shown in FIG. 1 would indicate that a suitable reduction temperature of an oxidized form of cobalt is from 350° C.-450° C. Literature reports that 350° C. to 365° C. is the range for optimum reduction for a Co-based catalyst (History of Cobalt Catalyst Design for Fischer-Tropsch Synthesis, Calvin H. Bartholomew and Brigham Young U).

However, contrary to the literature and the TRP, the methods disclosed herein utilize a lower temperature, such as 220° C. to 270° C., to reduce a cobalt catalyst for a prolonged period of time in the presence of a reducing gas, such as a first reducing and/or second reducing gas and/or third reducing gas.

Reduction temperature has a cost meaning in commercial reactors in case of in-situ reduction. High reduction temperatures, such as 350° C.-450° C., require that the reduction reactor have thick shells to withstand the reduction conditions. In multi-tubular reactor this becomes an issue since every tube in the reactor must have the required thickness. The cost of producing/purchasing and operating such reactors is significant. It is less expensive to produce/purchase and operate reactors that operate under methods that use lower temperatures, such as 220° C. to 270° C., because the less thickness of the shells are required the energy cost for miming the reactors is lower.

The reduced cobalt catalyst, produced by the methods disclosed herein, have a desired activity in a process of producing hydrocarbons from syngas. For example, the cobalt catalyst produced by the methods disclosed herein produces less methane when contacted with syngas at 5 bar at 230° C. than a reference cobalt catalyst that was reduced and activated using a substantially identical method as the cobalt catalyst but at a temperature from 300° C. to 450° C. and was contacted under the same conditions as the catalyst. In another example, the cobalt catalyst produced by the methods disclosed herein produces at least the same amount of C2-C6 hydrocarbons when contacted with syngas at 5 bar at 230° C. than a reference cobalt catalyst that was reduced and activated using a substantially identical method as the cobalt catalyst but at a temperature from 300° C. to 450° C. and was contacted under the same conditions as the catalyst. For example, cobalt catalyst produced by the methods disclosed herein produces less methane when contacted with syngas at 5 bar at 230° C. than a reference cobalt catalyst that was reduced and activated using a substantially identical method as the cobalt catalyst but at a temperature from 300° C. to 450° C. and was contacted under the same conditions as the catalyst, and produces at least the same amount of C2-C6 hydrocarbons when contacted with syngas at 5 bar at 230° C. than a reference cobalt catalyst that was reduced and activated using a substantially identical method as the cobalt catalyst but at a temperature from 300° C. to 450° C. and was contacted under the same conditions as the catalyst.

Disclosed herein is a method of reducing and activating a cobalt catalyst comprising the step of: a) contacting an at least partially oxidized cobalt catalyst with a first reducing gas at a temperature from 220° C. to 270° C. for at least 50 hours, and/or b) contacting an at least partially oxidized cobalt catalyst with a second reducing gas consisting essentially of H₂ at a temperature from 220° C. to 270° C. for at least 8 hours, thereby reducing and activating the cobalt catalyst.

In one aspect, the method comprises step a). In another aspect, the method comprises step b). In yet another aspect, the method comprises steps a) and b). When the method comprises both steps a) and b), then the steps are performed in separate steps. For example, step b) can first per performed followed by step a).

In one aspect, the method consists essentially of step a). In another aspect, the method consists essentially of step b). In yet another aspect, the method consists essentially of steps a) and b).

In one aspect, the method consists of step a). In another aspect, the method consists of step b). In yet another aspect, the method consists of steps a) and b).

Also disclosed herein is a method of reducing and activating a cobalt catalyst comprising the step of: a) contacting an at least partially oxidized cobalt catalyst with a third reducing gas at a temperature from 220° C. to 270° C. for at least 8 hours, wherein the third reducing gas comprises an amount of H₂ sufficient to reduce and activate the cobalt catalyst, thereby reducing and activating the cobalt catalyst.

Also disclosed herein is a method of reducing and activating a cobalt catalyst consisting essentially of the step of: a) contacting an at least partially oxidized cobalt catalyst with a first reducing gas at a temperature from 220° C. to 270° C. for at least 50 hours, thereby reducing and activating the cobalt catalyst.

Also disclosed herein is a method of reducing and activating a cobalt catalyst consisting essentially of the step of: a) contacting an at least partially oxidized cobalt catalyst with a second reducing gas consisting essentially of H₂ at a temperature from 220° C. to 270° C. for at least 8 hours, thereby reducing and activating the cobalt catalyst.

Also disclosed herein is a method of reducing and activating a cobalt catalyst consisting essentially of the step of: a) contacting an at least partially oxidized cobalt catalyst with a third reducing gas at a temperature from 220° C. to 270° C. for at least 8 hours, wherein the third reducing gas comprises an amount of H₂ sufficient to reduce and activate the cobalt catalyst, thereby reducing and activating the cobalt catalyst.

Also disclosed herein is a method of reducing and activating a cobalt catalyst consisting of the step of: a) contacting an at least partially oxidized cobalt catalyst with a first reducing gas at a temperature from 220° C. to 270° C. for at least 50 hours, thereby reducing and activating the cobalt catalyst.

Also disclosed herein is a method of reducing and activating a cobalt catalyst consisting of the step of: a) contacting an at least partially oxidized cobalt catalyst with a second reducing gas consisting essentially of H₂ at a temperature from 220° C. to 270° C. for at least 8 hours, thereby reducing and activating the cobalt catalyst.

Also disclosed herein is a method of reducing and activating a cobalt catalyst consisting of the step of: a) contacting an at least partially oxidized cobalt catalyst with a third reducing gas at a temperature from 220° C. to 270° C. for at least 8 hours, wherein the third reducing gas comprises an amount of H₂ sufficient to reduce and activate the cobalt catalyst, thereby reducing and activating the cobalt catalyst.

In one aspect, the first reducing gas comprises H₂. In another aspect, the first reducing gas comprises H₂ and N₂. For example, the first reducing gas can comprise H₂ and N₂ at a mole ratio from 2:1 to 1:2. In another example, the first reducing gas can comprise H₂ and N₂ at a mole ratio from 1.5:1 to 1:1.5. In yet another example, the first reducing gas can comprise H₂ and N₂ at a mole ratio from about 1:1 to 1:1, such as 1:1 to 1:1.

In one aspect, the second reducing gas consists essentially of H₂. In another aspect, the second reducing gas consists of H₂. A second reducing gas that consists essentially of H₂ comprises at least about 98% (v/v) of H₂, at least about 99% (v/v) of H₂, or at least about 99.5% (v/v) of H₂. A second reducing gas that consists of H₂ comprises at least about 99.6% (v/v) of H₂, at least about 99.9% (v/v) of H₂, at least about 99.99% (v/v) of H₂, or 100% (v/v) of H₂.

As referred to herein, the phrase “contacting an at least partially oxidized cobalt catalyst with a third reducing gas at a temperature from 220° C. to 270° C. for at least 8 hours, wherein the third reducing gas comprises an amount of H₂ sufficient to reduce and activate the cobalt catalyst, thereby reducing and activating the cobalt catalyst” means that there is a large enough concentration of H₂ present in the third reducing gas to reduce and activate the cobalt catalyst for the amount of time the method is performed. For example, as shown in the Examples disclosed herein, a higher concentration of H₂ in the third reducing gas requires less time to reduce and activate the cobalt catalyst. In a non-limiting example, less reduction and activation time is needed when the third reducing gas comprises at least 95 mole % of H₂ as compared to a third reducing gas comprising less than 95 mole % of H₂, such as, less than 80 mole % of H₂, or less than 60 mole % of H₂. Thus, by using a higher concentration (amount) of H₂ in the third reducing gas, less time and energy is required to reduce and activate the cobalt catalyst. The amount of H₂ in the third reducing gas can be altered, for example, increased or decreased, during the method. In a non-limiting example, the amount of H₂ in the third reducing gas can be increased during the method. Said differently a gas with a higher amount of H₂ than the third reducing gas can be added to the third reducing gas, thereby increasing the amount of H₂ in the third reducing gas.

In one aspect, the third reducing gas comprises H₂. In another aspect, the third reducing gas consists essentially of H₂. In yet another aspect, the second reducing gas consists of H₂. A third reducing gas comprising H₂ comprises at least about 65% (v/v) of H₂, at least about 80% (v/v) of H₂, at least about 90% (v/v) of H₂, at least about 95% (v/v) of H₂, at least about 98% (v/v) of H₂, at least about 99% (v/v) of H₂, or at least about 99.5% (v/v) of H₂

In one aspect, the third reducing gas further comprises N₂.

In one aspect, the at least partially oxidized cobalt catalyst has the structure Co_{y}Oₓ, wherein y is an integer from 1 to 3, and wherein x is an integer from 1 to 4, and wherein x and y are in a stoichiometric ratio. In one aspect, y can be 1, 2, or 3. For example, y can be 1. In another example, y can be 2. In yet another example, y can be 3. In one aspect x can be 1, 2, 3, or 4. For example, x can be 1. In another example, x can be 2. In yet another example, x can be 3. In yet another example, x can be 4. In one aspect, y can be 1 and x can be 1. In another aspect, y can be 2 and x can be 3. In yet another aspect, y can be 3 and x can be 4.

In one aspect, the at least partially oxidized cobalt catalyst has the structure Co₃O₄

In one aspect, the at least partially oxidized cobalt catalyst has the structure Co₂O₃

In one aspect, the at least partially oxidized cobalt catalyst has the structure CoO.

In one aspect, the temperature, in the step of contacting an at least partially oxidized cobalt catalyst with a first reducing gas, is from 230° C. to 260° C. In another aspect, the temperature, in the step of contacting an at least partially oxidized cobalt catalyst with a first reducing gas, is from 240° C. to 260° C. In yet another aspect, the temperature, in the step of contacting an at least partially oxidized cobalt catalyst with a first reducing gas, is from 245° C. to 255° C. For example, the temperature, in the step of contacting an at least partially oxidized cobalt catalyst with a first reducing gas, can be about 230° C., 235° C., 240° C., 245° C., 250° C., 255° C., 260° C., 265° C., or 270° C., such as, for example, about 250° C.

In one aspect, the temperature, in the step of contacting an at least partially oxidized cobalt catalyst with a second reducing gas, is from 230° C. to 260° C. In another aspect, the temperature, in the step of contacting an at least partially oxidized cobalt catalyst with a second reducing gas, is from 240° C. to 260° C. In yet another aspect, the temperature, in the step of contacting an at least partially oxidized cobalt catalyst with a second reducing gas, is from 245° C. to 255° C. For example, the temperature, in the step of contacting an at least partially oxidized cobalt catalyst with a second reducing gas, can be about 230° C., 235° C., 240° C., 245° C., 250° C., 255° C., 260° C., 265° C., or 270° C., such as, for example, about 250° C.

In one aspect, the temperature, in the step of contacting an at least partially oxidized cobalt catalyst with a third reducing gas, is from 230° C. to 260° C. In another aspect, the temperature, in the step of contacting an at least partially oxidized cobalt catalyst with a third reducing gas, is from 240° C. to 260° C. In yet another aspect, the temperature, in the step of contacting an at least partially oxidized cobalt catalyst with a third reducing gas, is from 245° C. to 255° C. For example, the temperature, in the step of contacting an at least partially oxidized cobalt catalyst with a third reducing gas, can be about 230° C., 235° C., 240° C., 245° C., 250° C., 255° C., 260° C., 265° C., or 270° C., such as, for example, about 250° C.

In one aspect, the contacting with the first reducing gas can be for at least 50 hours, 55 hours, 60 hours, 65 hours, 70 hours, 75 hours, 80 hours, or 90 hours. For example, the contacting with the first reducing gas can be can be for at least 60 hours or 65 hours.

In one aspect, the contacting with the first reducing gas can be is from 50 hours to 90 hours. For example, the contacting with the first reducing gas can be can be from 55 hours to 85 hours, from 60 hours to 80 hours, or from 65 hours to 75 hours, such as, for example, from 60 hours to 80 hours.

In one aspect, the contacting with the second reducing gas can be for at least 8 hours, 10 hours, 15 hours, 20 hours, 25 hours, 30 hours, 35 hours, or 40 hours. For example, the contacting with the first reducing gas can be can be for at least 10 hours or 15 hours.

In one aspect, the contacting with the second reducing gas can be is from 8 hours to 50 hours. For example, the contacting with the second reducing gas can be can be from 8 hours to 40 hours, from 10 hours to 30 hours, or from 10 hours to 25 hours, such as, for example, from 15 hours to 25 hours.

In one aspect, the contacting with the third reducing gas can be for at least 8 hours, 10 hours, 15 hours, 20 hours, 25 hours, 30 hours, 35 hours, 40 hours, 45 hours, 50 hours, 55 hours, 60 hours, 65 hours, 70 hours, 75 hours, 80 hours, or 90 hours. For example, the contacting with the first reducing gas can be can be for at least 10 hours, 15 hours, 35 hours, 50 hours, or 65 hours.

In one aspect, the contacting with the third reducing gas can be is from 8 hours to 90 hours. For example, the contacting with the second reducing gas can be can be from 8 hours to 70 hours, from 8 hours to 50 hours, from 8 hours to 30 hours, from 8 hours to 20 hours, from 10 hours to 25 hours, from 15 hours to 90 hours, from 35 hours to 90 hours, from 50 hours to 90 hours, from 25 hours to 90 hours, from 25 hours to 70 hours, or from 25 hours to 50 hours.

In one aspect, the method does not comprise contacting the at least partially oxidized cobalt catalyst or the reduced and activated cobalt catalyst with a first reducing gas at a temperature of at least 300° C. for a period of time.

In one aspect, the method does not comprise contacting the at least partially oxidized cobalt catalyst or the reduced and activated cobalt catalyst with a first reducing gas at a temperature from 300° C. to 450° C. For example, method does not comprise contacting the at least partially oxidized cobalt catalyst or the reduced and activated cobalt catalyst with a first reducing gas at a temperature from 300° C. to 450° C. for a period of time.

In one aspect, the method does not comprise contacting the at least partially oxidized cobalt catalyst or the reduced and activated cobalt catalyst with a second reducing gas at a temperature of at least 300° C. for a period of time.

In one aspect, the method does not comprise contacting the at least partially oxidized cobalt catalyst or the reduced and activated cobalt catalyst with a second reducing gas at a temperature from 300° C. to 450° C. For example, method does not comprise contacting the at least partially oxidized cobalt catalyst or the reduced and activated cobalt catalyst with a second reducing gas at a temperature from 300° C. to 450° C. for a period of time.

In one aspect, the method does not comprise contacting the at least partially oxidized cobalt catalyst or the reduced and activated cobalt catalyst with a third reducing gas at a temperature of at least 300° C. for a period of time.

In one aspect, the method does not comprise contacting the at least partially oxidized cobalt catalyst or the reduced and activated cobalt catalyst with a third reducing gas at a temperature from 300° C. to 450° C. For example, method does not comprise contacting the at least partially oxidized cobalt catalyst or the reduced and activated cobalt catalyst with a second reducing gas at a temperature from 300° C. to 450° C. for a period of time.

In one aspect, the period of time is at least 1 min, 15 min, 30 min, 45 min, 1 hour, 1.5 hours, 2 hours, 3 hours, or 5 hours. For example, the period of time can be from 1 min to 5 hours.

In one aspect, the method does not comprise an oxidizing step, such as, for example, an oxidizing step of any cobalt catalyst disclosed herein.

In one aspect, the method disclosed herein produces a cobalt catalyst that has at least the same CO conversion activity as compared to a cobalt catalyst that was reduced and activated with an identical first reducing gas at a temperature from 300° C. to 450° C. for the same period of time, wherein the CO conversion rate is measured from a reaction of CO and H₂ at a ratio of 1 to 2, at 5 bar, at 240° C., at a space velocity of 1875 Nm/h/g. In another aspect, the method disclosed herein produces a cobalt catalyst that has a higher CO conversion activity as compared to a cobalt catalyst that was reduced and activated with an identical first reducing gas at a temperature from 300° C. to 450° C. for the same period of time, wherein the CO conversion rate is measured from a reaction of CO and H₂ at a ratio of 1 to 2, at 5 bar, at 240° C., at a space velocity of 1875 Nm/h/g.

In one aspect, the method disclosed herein produces a cobalt catalyst that has at least the same CO conversion activity as compared to a cobalt catalyst that was reduced and activated with an identical second reducing gas at a temperature from 300° C. to 450° C. for the same period of time, wherein the CO conversion rate is measured from a reaction of CO and H₂ at a ratio of 1 to 2, at 5 bar, at 240° C., at a space velocity of 1875 Nm/h/g. In another aspect, the method disclosed herein produces a cobalt catalyst that has a higher CO conversion activity as compared to a cobalt catalyst that was reduced and activated with an identical second reducing gas at a temperature from 300° C. to 450° C. for the same period of time, wherein the CO conversion rate is measured from a reaction of CO and H₂ at a ratio of 1 to 2, at 5 bar, at 240° C., at a space velocity of 1875 Nm/h/g.

In one aspect, the method disclosed herein produces a cobalt catalyst that has at least the same CO conversion activity as compared to a cobalt catalyst that was reduced and activated with an identical third reducing gas at a temperature from 300° C. to 450° C. for the same period of time, wherein the CO conversion rate is measured from a reaction of CO and H₂ at a ratio of 1 to 2, at 5 bar, at 240° C., at a space velocity of 1875 Nm/h/g. In another aspect, the method disclosed herein produces a cobalt catalyst that has a higher CO conversion activity as compared to a cobalt catalyst that was reduced and activated with an identical third reducing gas at a temperature from 300° C. to 450° C. for the same period of time, wherein the CO conversion rate is measured from a reaction of CO and H₂ at a ratio of 1 to 2, at 5 bar, at 240° C., at a space velocity of 1875 Nm/h/g.

The method disclosed herein can be performed on an industrial scale for the production of large quantities of cobalt catalyst. For example, the method disclosed herein can be used to produce at least 1 gram, 10 gram, 50 gram, 100 gram, 250 gram, 500 gram, 750 gram, 1,000 gram, or 2,500 gram of cobalt catalyst. For example, the method disclosed herein can be used to produce at least 100 gram, 250 gram, 500 gram, 750 gram, 1,000 gram, or 2,500 gram of the reduced and activated cobalt catalyst, such as, at least 500 gram, 750 gram, or 1,000 gram of the reduced and activated cobalt catalyst. In another example, the method disclosed herein can be used to produce from 1 gram to 2,500 gram of cobalt catalyst, such as, for example, from 100 gram to 2,500 gram, or from 500 gram to 2,500 gram of cobalt catalyst.

3. Catalysts

Described herein are cobalt catalysts produced by any one of the methods disclosed herein.

In one aspect, disclosed herein is a cobalt catalyst produced by the method of reducing and activating a cobalt catalyst comprising the step of: a) contacting an at least partially oxidized cobalt catalyst with a first reducing gas at a temperature from 220° C. to 270° C. for at least 50 hours, and/or b) contacting an at least partially oxidized cobalt catalyst with a second reducing gas consisting essentially of H₂ at a temperature from 220° C. to 270° C. for at least 8 hours, thereby reducing and activating the cobalt catalyst.

In another aspect, disclosed herein is a cobalt catalyst produced by the method of reducing and activating a cobalt catalyst comprising the step of: a) contacting an at least partially oxidized cobalt catalyst with a third reducing gas at a temperature from 220° C. to 270° C. for at least 8 hours, wherein the third reducing gas comprises an amount of H₂ sufficient to reduce and activate the cobalt catalyst, thereby reducing and activating the cobalt catalyst.

In yet another aspect, disclosed herein is a cobalt catalyst produced by the method of reducing and activating a cobalt catalyst consisting essentially of the step of: a) contacting an at least partially oxidized cobalt catalyst with a first reducing gas at a temperature from 220° C. to 270° C. for at least 50 hours, thereby reducing and activating the cobalt catalyst.

In yet another aspect, disclosed herein is a cobalt catalyst produced by the method of reducing and activating a cobalt catalyst consisting essentially of the step of: a) contacting an at least partially oxidized cobalt catalyst with a second reducing gas consisting essentially of H₂ at a temperature from 220° C. to 270° C. for at least 8 hours, thereby reducing and activating the cobalt catalyst.

Also disclosed herein are cobalt catalysts produced by any one of the methods disclosed herein and a support, such as alumina or titania.

In one aspect, the cobalt catalyst has a desired activity in a process of producing hydrocarbons from syngas. For example, the cobalt catalyst can produce less methane when contacted with syngas at 5 bar at 230° C. than a reference cobalt catalyst that was reduced and activated using a substantially identical method as the cobalt catalyst but at a temperature from 300° C. to 450° C. and was contacted under the same conditions as the cobalt catalyst. In another example, the cobalt catalyst can produce at least the same amount of C2-C6 hydrocarbons when contacted with syngas at 5 bar at 230° C. than a reference cobalt catalyst that was reduced and activated using a substantially identical method as the cobalt catalyst but at a temperature from 300° C. to 450° C. and was contacted under the same conditions as the cobalt catalyst. For example, the cobalt catalyst can produce less methane when contacted with syngas at 5 bar at 230° C. than a reference cobalt catalyst that was reduced and activated using a substantially identical method as the cobalt catalyst but at a temperature from 300° C. to 450° C. and was contacted under the same conditions as the catalyst, and produces at least the same amount of C2-C6 hydrocarbons when contacted with syngas at 5 bar at 230° C. than a reference cobalt catalyst that was reduced and activated using a substantially identical method as the cobalt catalyst but at a temperature from 300° C. to 450° C. and was contacted under the same conditions as the catalyst.

In one aspect, the cobalt catalyst disclosed herein can produce at least 0.1%, 0.5%, 1%, 1.5%, 2%, 2.5%, 5%, 10%, 15%, 20%, 35%, 30%, or 50% less methane when contacted with syngas at 5 bar at 230° C. than a reference cobalt catalyst that was reduced and activated using a substantially identical method as the cobalt catalyst but at a temperature from 300° C. to 450° C. and was contacted under the same conditions as the cobalt catalyst.

In one aspect, the cobalt catalyst can produce from 0.1% to 50%, such as, for example, from 10% to 30% less methane when contacted with syngas at 5 bar at 230° C. than a reference cobalt catalyst that was reduced and activated using a substantially identical method as the cobalt catalyst but at a temperature from 300° C. to 450° C. and was contacted under the same conditions as the cobalt catalyst.

In one aspect, the cobalt catalyst disclosed herein can produce a greater amount of C2-C6 hydrocarbons when contacted with syngas at 5 bar at 230° C. than a reference cobalt catalyst that was reduced and activated using a substantially identical method as the cobalt catalyst but at a temperature from 300° C. to 450° C. and was contacted under the same conditions as the cobalt catalyst. For example, the cobalt catalyst disclosed herein can produce at least 0.1%, 0.2%, 0.3%, 0.5%, 0.7%, 1%, 1.5%, 2%, 2.5%, 3%, or 5% greater amount of C2-C6 hydrocarbons when contacted with syngas at 5 bar at 230° C. than a reference cobalt catalyst that was reduced and activated using a substantially identical method as the cobalt catalyst but at a temperature from 300° C. to 450° C. and was contacted under the same conditions as the cobalt catalyst.

In one aspect, the cobalt catalyst disclosed herein can produce from 0.1%, to 5% greater amount of C2-C6 hydrocarbons when contacted with syngas at 5 bar at 230° C. than a reference cobalt catalyst that was reduced and activated using a substantially identical method as the cobalt catalyst but at a temperature from 300° C. to 450° C. and was contacted under the same conditions as the cobalt catalyst.

4. Methods For Producing Hydrocarbons From Syngas

Described above is a cobalt catalyst and method for making the cobalt catalyst. The cobalt catalyst is useful for converting mixtures of carbon monoxide and hydrogen (syngas) to hydrocarbons, such as, C1-C6 hydrocarbons, for example C2-C6 hydrocarbons.

Also disclosed herein is a method of producing hydrocarbons comprising contacting syngas with a cobalt catalyst disclosed herein, thereby producing hydrocarbons.

Also disclosed herein are methods of producing C2-C6 hydrocarbons comprising contacting syngas with a cobalt catalyst disclosed herein, thereby producing C2-C6 hydrocarbons.

The cobalt catalyst compositions disclosed herein are suitable to be introduced to conditions suitable for contacting and reacting the cobalt catalyst composition with syngas. Such conditions are known in the art and include high temperatures.

In these methods, mixtures of carbon monoxide and hydrogen (syngas) are contacted with suitable catalysts in suitable reactors and at suitable temperatures and pressures, for a contact time and/or at a suitable space velocity needed in order to convert at least some of the syngas to hydrocarbons. Non-limiting examples of suitable catalysts are described elsewhere herein. As compared to methods in the prior art, the methods of the present inventions can be highly selective for the production of C2-C6 hydrocarbons, which are valuable feedstocks for subsequent cracking processes at refineries for producing downstream products, such as low molecular weight olefins.

Methods for producing syngas from natural gas, coal, or waste streams or biomass, at almost any desired ratio of hydrogen to carbon monoxide are well known to those of ordinary skill in the art. A large range of ratios of hydrogen to carbon monoxide can be suitable for the practice of the current invention, but since high conversion of carbon monoxide to hydrocarbons is desired, syngas mixtures comprising at least equimolar ratios of hydrogen to carbon monoxide or higher are typically employed, i.e. from 3:1 H₂/CO to 1:1 H₂/CO. In some aspects, the ratios of hydrogen to carbon monoxide employed are from 2:1 H₂/CO to 1:1 H₂/CO. Optionally, inert or reactive carrier gases, such as N₂, CO₂, methane, ethane, propane, and the like can be contained in and/or mixed with the syngas.

The syngas is typically forced to flow through reactors comprising the solid cobalt catalysts, wherein the reactors are designed to retain the catalyst against the vapor phase flow of syngas, at temperatures sufficient to maintain most of the hydrocarbon products of the catalytic reactions in the vapor phase at the selected operating pressures. The cobalt catalyst particles can be packed into a fixed bed, or dispersed in a fluidized bed, or in other suitable arrangements known to those of ordinary skill in the art.

In one aspect, the syngas is contacted with the cobalt catalyst compositions at a temperature of at least 200° C., or at least 300° C., and at a temperature below 400° C. or from a temperature of 200° C. to 350° C.

In one aspect, the syngas is contacted with the cobalt catalyst compositions at a pressure of at least 5 bar, or at least, 10 bar, or at least 15 bar, or at least 25 bar, or at least 50 bar, or at least 75 bar, and less than 200 bar, or less than 100 bar. In many aspects of the methods of the reaction, the syngas is contacted with the cobalt catalyst compositions at a pressure of less than 100 bar, or less than 50 bar, or less than 30 bar, or less than 15 bar. In many aspects of the methods of the reaction, the syngas is contacted with the cobalt catalyst compositions at a pressure from 5 bar to 100 bar, such as, for example, from 5 bar to 30 bar.

In one aspect, the syngas is contacted with the catalyst compositions to produce relatively high conversions of the carbon monoxide present in syngas. In one aspect, conversion of carbon monoxide is at least 50%, at least 60%, at least 70%, at least 80%, or at least 85%. In some aspects of the methods, at least 40%, at least 50%, at least 60%, at least 70%, at least 80%, or at least 85% of the syngas is converted to product materials. In one aspect, less than 25%, less than 20%, or less than 15% of the carbon monoxide fed to the reactors is converted to CO₂.

In one aspect, the methods of the inventions are unexpectedly highly selective for the production of mixtures of low molecular weight C2-C6 hydrocarbons. Typical C2-C6 hydrocarbons detected in the product include saturated hydrocarbons such as ethane, propanes, butanes, and pentanes, and unsaturated hydrocarbons such as ethylenes, propylenes, butenes, and pentenes.

In view of the general descriptions of the cobalt catalyst compositions and variations thereof that are part of the inventions described above, herein below are described certain more particularly described aspects of methods for employing the catalysts for converting syngas to hydrocarbons. These particularly recited aspects should not however be interpreted to have any limiting effect on any different claims containing different or more general teachings, or that the “particular” aspects are somehow limited in some way other than the inherent meanings of the language and formulas literally used therein.

5. Aspects

In view of the described catalyst and catalyst compositions and methods and variations thereof, herein below are described certain more particularly described aspects of the inventions. These particularly recited aspects should not however be interpreted to have any limiting effect on any different claims containing different or more general teachings described herein, or that the “particular” aspects are somehow limited in some way other than the inherent meanings of the language and formulas literally used therein.

Aspect 1: A method of reducing and activating a cobalt catalyst comprising the step of: a) contacting an at least partially oxidized cobalt catalyst with a first reducing gas at a temperature from 220° C. to 270° C. for at least 50 hours, and/or b) contacting an at least partially oxidized cobalt catalyst with a second reducing gas consisting essentially of H₂ at a temperature from 220° C. to 270° C. for at least 8 hours, thereby reducing and activating the cobalt catalyst.

Aspect 2: The method of aspect 1, wherein the method comprises step a).

Aspect 3: The method of aspect 1, wherein the method comprises step b).

Aspect 4: The method of aspect 1, wherein the method comprises steps a) and b).

Aspect 5: The method of any one of aspects 1, 2 or 4, wherein the first reducing gas comprises H₂.

Aspect 6: The method of any one of aspects 1, 2, 4, or 5, wherein the first reducing gas comprises H₂ and N₂ at a mole ratio from 2:1 to 1:2.

Aspect 7: The method of any one of aspects 1, 3, or 4, wherein the second reducing gas consists of H₂.

Aspect 8: The method of any one of aspects 1-7, wherein the at least partially oxidized cobalt catalyst has the structure Co_{y}Oₓ, wherein y is an integer from 1 to 3, and wherein x is an integer from 1 to 4, and wherein x and y are in a stoichiometric ratio.

Aspect 9: The method of aspect 8, wherein the at least partially oxidized cobalt catalyst has the structure Co₃O₄

Aspect 10: The method of aspect 8, wherein the at least partially oxidized cobalt catalyst has the structure CoO.

Aspect 11: The method of any one of aspects 1-9, wherein the temperature in step a) and/or b) is from 230° C. to 260° C.

Aspect 12: The method of any one of aspects 1-9, wherein the temperature in step a) and/or b) is from 240° C. to 260° C.

Aspect 13: The method of any one of aspects 1-9, wherein the temperature in step a) and/or b) is from 245° C. to 255° C.

Aspect 14: The method of any one of aspects 1-9, wherein the temperature in step a) and/or b) is about 250° C.

Aspect 15: The method of any one of aspects 1, 2, 4-6, or 8-14, wherein the contacting with the first reducing gas is from 50 hours to 90 hours.

Aspect 16: The method of any one of aspects 1, 2, 4-6, or 8-14, wherein the contacting with a first reducing gas is from 60 hours to 80 hours.

Aspect 17: The method of any one of aspects 1, 2, 4-6, or 8-14, wherein the contacting with a first reducing gas is for at least 65 hours.

Aspect 18: The method of any one of aspects 1, 3, 4, or 7-14, wherein the contacting with the second reducing gas is from 8 hours to 90 hours.

Aspect 19: The method of any one of aspects 1, 3, 4, or 7-14, wherein the contacting with the second reducing gas is from 8 hours to 50 hours.

Aspect 20: The method of any one of aspects 1, 3, 4, or 7-14, wherein the contacting with the second reducing gas is from 8 hours to 30 hours.

Aspect 21: The method of any one of aspects 1, 3, 4, or 7-14, wherein the contacting with the second reducing gas is from 8 hours to 25 hours.

Aspect 22: The method of any one of aspects 1, 3, 4, or 7-14, wherein the contacting with the second reducing gas is for at least 15 hours.

Aspect 23: The method of any one of aspects 1-22, wherein the method does not comprise contacting the at least partially oxidized cobalt catalyst or the reduced and activated cobalt catalyst with a first reducing gas or a second reducing gas at a temperature of at least 300° C. for a period of time.

Aspect 24: The method of aspect 23, wherein the period of time is at least 15 min.

Aspect 25: The method of aspect 23, wherein the period of time is at least 1 hr.

Aspect 26: The method of any one of aspects 1-23, wherein the method does not comprise contacting the at least partially oxidized cobalt catalyst or the reduced and activated cobalt catalyst with a first reducing gas or a second reducing gas at a temperature from 300° C. to 450° C.

Aspect 27: The method of any one of aspects 1-26, wherein the method does not comprise an oxidizing step.

Aspect 28: The method of any one of aspects 1-27, wherein the cobalt catalyst is fully oxidized prior to reducing and activating the cobalt catalyst.

Aspect 29: The method of any one of aspects 1, 2, 5, 6, 8-17, or 23-28, wherein the method consists essentially of step a).

Aspect 30: The method of any one of aspects 1, 3, 7-14, or 18-28, wherein the method consists essentially of step b).

Aspect 31: A method of reducing and activating a cobalt catalyst comprising the step of: a) contacting an at least partially oxidized cobalt catalyst with a third reducing gas at a temperature from 220° C. to 270° C. for at least 8 hours, wherein the third reducing gas comprises an amount of H₂ sufficient to reduce and activate the cobalt catalyst, thereby reducing and activating the cobalt catalyst.

Aspect 32: The method of aspect 31, wherein the third reducing gas comprises at least 65% (v/v) of H₂.

Aspect 33: The method of aspect 31, wherein the third reducing gas comprises at least 80% (v/v) of H₂.

Aspect 34: The method of aspect 31, wherein the third reducing gas comprises at least 90% (v/v) of H₂.

Aspect 35: The method of aspect 31, wherein the third reducing gas comprises at least 95% (v/v) of H₂.

Aspect 36: The method of aspect 31, wherein the third reducing gas comprises at least 99% (v/v) of H₂.

Aspect 37: The method of any one of aspects 31-36, wherein the wherein the contacting with the third reducing gas is from 8 hours to 90 hours.

Aspect 38: The method of any one of aspects 31-36, wherein the contacting with the third reducing gas is from 8 hours to 50 hours.

Aspect 39: The method of any one of aspects 31-36, wherein the contacting with the third reducing gas is from 8 hours to 30 hours.

Aspect 40: The method of any one of aspects 31-36, wherein the contacting with the third reducing gas is from 8 hours to 25 hours.

Aspect 41: The method of any one of aspects 31-36, wherein the contacting with the third reducing gas is from 25 hours to 90 hours.

Aspect 42: The method of any one of aspects 31-36, wherein the contacting with the third reducing gas is from 25 hours to 70 hours.

Aspect 43: The method of any one of aspects 31-36, wherein the contacting with the third reducing gas is from 25 hours to 50 hours.

Aspect 44: The method of any one of aspects 31-36, wherein the contacting with the third reducing gas is for at least 15 hours.

Aspect 45: The method of any one of aspects 31-44, wherein the at least partially oxidized cobalt catalyst has the structure Co_{y}Oₓ, wherein y is an integer from 1 to 3, and wherein x is an integer from 1 to 4, and wherein x and y are in a stoichiometric ratio.

Aspect 46: The method of aspect 45, wherein the at least partially oxidized cobalt catalyst has the structure Co₃O₄.

Aspect 47: The method of aspect 45, wherein the at least partially oxidized cobalt catalyst has the structure CoO.

Aspect 48: The method of any one of aspects 31-47, wherein the temperature in step a) is from 230° C. to 260° C.

Aspect 49: The method of any one of aspects 31-47, wherein the temperature in step a) is from 240° C. to 260° C.

Aspect 50: The method of any one of aspects 31-47, wherein the temperature in step a) is from 245° C. to 255° C.

Aspect 51: The method of any one of aspects 31-47, wherein the temperature in step a) is about 250° C.

Aspect 52: The method of any one of aspects 31-51, wherein the method does not comprise contacting the at least partially oxidized cobalt catalyst or the reduced and activated cobalt catalyst with a third reducing gas at a temperature of at least 300° C. for a period of time.

Aspect 53: The method of aspect 52, wherein the period of time is at least 15 min.

Aspect 54: The method of aspect 52, wherein the period of time is at least 1 hr.

Aspect 55: The method of any one of aspects 31-52, wherein the method does not comprise contacting the at least partially oxidized cobalt catalyst or the reduced and activated cobalt catalyst with a third reducing gas at a temperature from 300° C. to 450° C.

Aspect 56: The method of any one of aspects 31-55, wherein the method does not comprise an oxidizing step.

Aspect 57: The method of any one of aspects 31-56, wherein the cobalt catalyst is fully oxidized prior to reducing and activating the cobalt catalyst.

Aspect 58: The method of any one of aspects 31-57, wherein the method produces a cobalt catalyst that has at least the same CO conversion activity as compared to a cobalt catalyst that was reduced and activated with an identical third reducing gas at a temperature from 300° C. to 450° C. for the same period of time, wherein the CO conversion rate is measured from a reaction of CO and H₂ at a ratio of 1 to 2, at 5 bar, at 240° C., at a space velocity of 1875 Nm/h/g.

Aspect 59: The method of any one of aspects 31-58, wherein the third reducing gas further comprises N₂.

Aspect 60: A method of reducing and activating a cobalt catalyst consisting essentially of the step of: a) contacting an at least partially oxidized cobalt catalyst with a first reducing gas at a temperature from 220° C. to 270° C. for at least 50 hours, thereby reducing and activating the cobalt catalyst.

Aspect 61: The method of aspect 60, wherein the first reducing gas comprises H₂.

Aspect 62: The method of aspects 60 or 61, wherein the first reducing gas comprises H₂ and N₂ at a mole ratio from 2:1 to 1:2.

Aspect 63: The method of any one of aspects 60-62, wherein the at least partially oxidized cobalt catalyst has the structure Co_{y}Oₓ, wherein y is an integer from 1 to 3, and wherein x is an integer from 1 to 4.

Aspect 64: The method of aspect 63, wherein the at least partially oxidized cobalt catalyst has the structure Co₃O₄.

Aspect 65: The method of aspect 63, wherein the at least partially oxidized cobalt catalyst has the structure CoO.

Aspect 66: The method of any one of aspects 60-64, wherein the temperature is from 230° C. to 260° C.

Aspect 67: The method of any one of aspects 60-64, wherein the temperature is from 240° C. to 260° C.

Aspect 68: The method of any one of aspects 60-64, wherein the temperature is from 245° C. to 255° C.

Aspect 69: The method of any one of aspects 60-64, wherein the temperature is about 250° C.

Aspect 70: The method of any one of aspects 60-69, wherein the contacting is from 50 hours to 90 hours.

Aspect 71: The method of any one of aspects 60-69, wherein the contacting is from 60 hours to 80 hours.

Aspect 72: The method of any one of aspects 60-69, wherein the contacting is for at least 65 hours.

Aspect 73: The method of any one of aspects 60-69, wherein the cobalt catalyst is fully oxidized prior to reducing and activating the cobalt catalyst.

Aspect 74: A method of reducing and activating a cobalt catalyst consisting essentially of the step of: a) contacting an at least partially oxidized cobalt catalyst with a second reducing gas consisting essentially of H₂ at a temperature from 220° C. to 270° C. for at least 8 hours, thereby reducing and activating the cobalt catalyst.

Aspect 75: The method of aspect 74, wherein the second reducing gas consists of H₂.

Aspect 76: The method of aspects 74 or 75, wherein the at least partially oxidized cobalt catalyst has the structure Co_{y}Oₓ, wherein y is an integer from 1 to 3, and wherein x is an integer from 1 to 4.

Aspect 77: The method of aspect 76, wherein the at least partially oxidized cobalt catalyst has the structure Co₃O₄.

Aspect 78: The method of aspect 76, wherein the at least partially oxidized cobalt catalyst has the structure CoO.

Aspect 79: The method of any one of aspects 74-78, wherein the temperature is from 230° C. to 260° C.

Aspect 80: The method of any one of aspects 74-78, wherein the temperature is from 240° C. to 260° C.

Aspect 81: The method of any one of aspects 74-78, wherein the temperature is from 245° C. to 255° C.

Aspect 82: The method of any one of aspects 74-78, wherein the temperature is about 250° C.

Aspect 83: The method of any one of aspects 74-82, wherein the wherein the contacting with the second reducing gas is from 8 hours to 90 hours.

Aspect 84: The method of any one of aspects 74-82, wherein the contacting with the second reducing gas is from 8 hours to 50 hours.

Aspect 85: The method of any one of aspects 74-82, wherein the contacting with the second reducing gas is from 8 hours to 30 hours.

Aspect 86: The method of any one of aspects 74-82, wherein the contacting with the second reducing gas is from 8 hours to 25 hours.

Aspect 87: The method of any one of aspects 74-82, wherein the cobalt catalyst is fully oxidized prior to reducing and activating the cobalt catalyst.

Aspect 88: A cobalt catalyst produced by any one of the methods of aspects 1-87.

Aspect 89: The cobalt catalyst of aspect 74, wherein the cobalt catalyst produces less methane when contacted with syngas at 5 bar at 230° C. than a reference cobalt catalyst that was reduced and activated using a substantially identical method as the cobalt catalyst but at a temperature from 300° C. to 450° C. and was contacted under the same conditions as the catalyst of aspect 88.

Aspect 90: The cobalt catalyst of aspects 74 or 89, wherein the cobalt catalyst produces at least the same amount of C2-C6 hydrocarbons when contacted with syngas at 5 bar at 230° C. than a reference cobalt catalyst that was reduced and activated using a substantially identical method as the cobalt catalyst but at a temperature from 300° C. to 450° C. and was contacted under the same conditions as the catalyst of aspect 88.

Aspect 91: A method of producing hydrocarbons comprising the step: a) contacting the cobalt catalyst of any one of aspects 88-90 with syngas, thereby producing hydrocarbons.

### EXAMPLES

The following examples are put forth so as to provide those of ordinary skill in the art with a complete disclosure and description of how the compounds, compositions, articles, devices, and/or methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### 1. Example 1

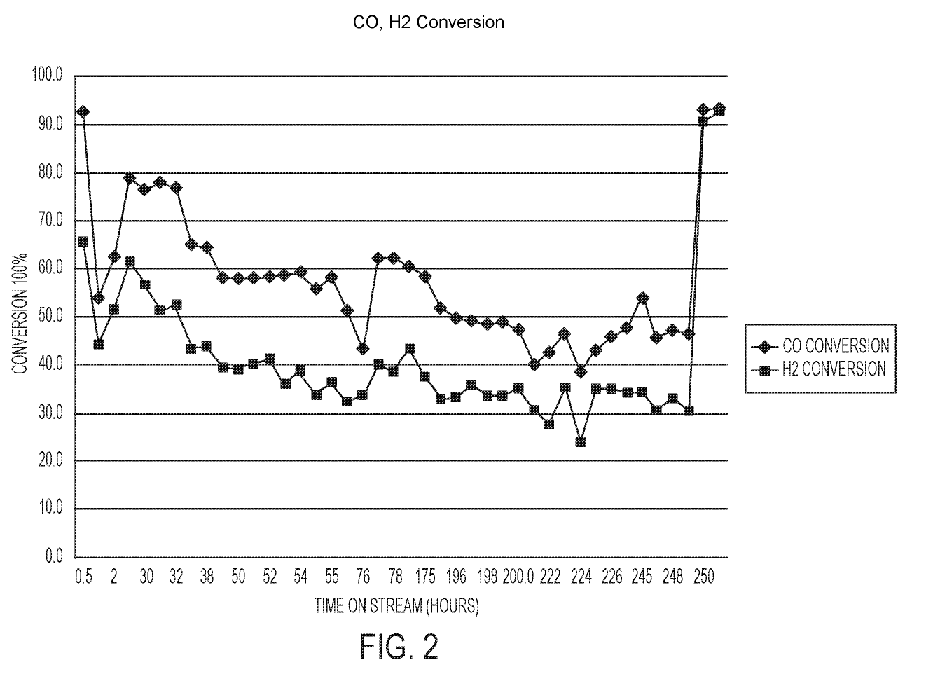

FIG. 2 shows that the CO and H₂ conversion is stable overtime for a cobalt catalyst that has been reduced at 250° C. for about 65 hours. An oxidized form of cobalt, comprising Co₃O₄, was reduced at 1 atm with H₂:N₂ at a 1:1 ratio at 250° C. for about 65 hours, to provide for the reduced and activated cobalt catalyst. Accordingly, FIG. 2 shows that cobalt catalysts prepared with the methods disclosed herein have a desired activity and stability.

An oxidized form of cobalt, comprising Co₃O₄, was reduced at 1 atm with H₂:N₂ at a 1:1 ratio at 250° C. for about 65 hours.

### 2. Example 2

The activity of a cobalt catalyst reduced and activated by some of the aspects of the methods disclosed herein was compared to a cobalt catalyst that was reduced and activated using conventional activation procedures. Table 1 shows the reduction and activation procedures for the cobalt catalysts and the process conditions for syngas conversion to hydrocarbons. An oxidized form of cobalt, comprising Co₃O₄, was reduced using the parameters described in Table 1.

TABLE 1

| Standard activation | Modified activation |
|---|---|
| 100 Nml/min H₂:N₂ = 1 | 100 Nml/min H₂:N₂ = 1 |
| Heating from ambient to 350° C. | Heating from ambient to 250° C. |
| at 3° C./min | at 3° C./min |
| Maintained at 350° C. for 16 h | Maintained at 250° C. for 65 h |
| Flushed with 250 Nml/min He and | No flush, cooled to 230° C. |
| cooled to 230° C. | |
| Pressurized to 5 bar in He | Pressurized to 5 bar in syngas |
| Introduced syngas at 2400 Nml/g h | Introduced syngas at 2400 Nml/g h |

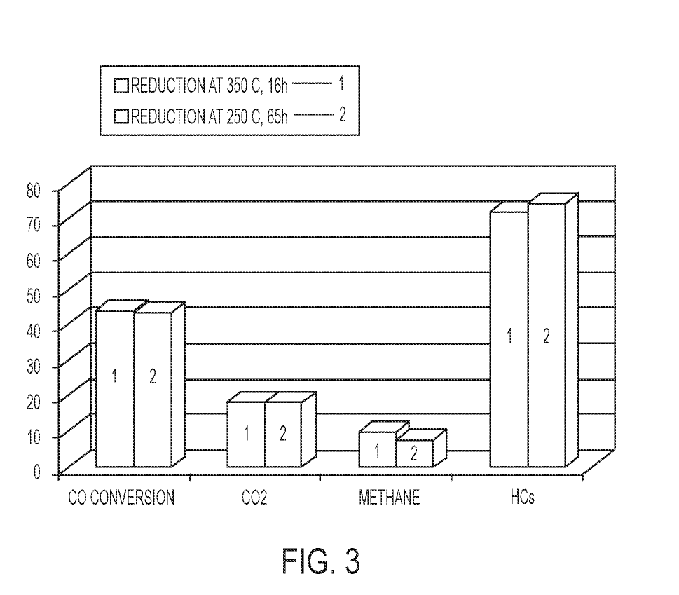

FIG. 3 shows that the catalyst prepared using the modified activations conditions described in Table 1 have the same or in some aspects better activity that a cobalt catalyst produced by standard activation procedures. For example, FIG. 3 shows that the production of methane is lower with the cobalt catalyst produced with the modified activation procedures. In another example, FIG. 3 shows that the production of hydrocarbons was higher with the cobalt catalyst produced with the modified activation procedures. In another example, FIG. 3 shows that the CO conversion and CO₂ production was the same with the cobalt catalyst produced with the modified activation procedures.

### 3. Example 3

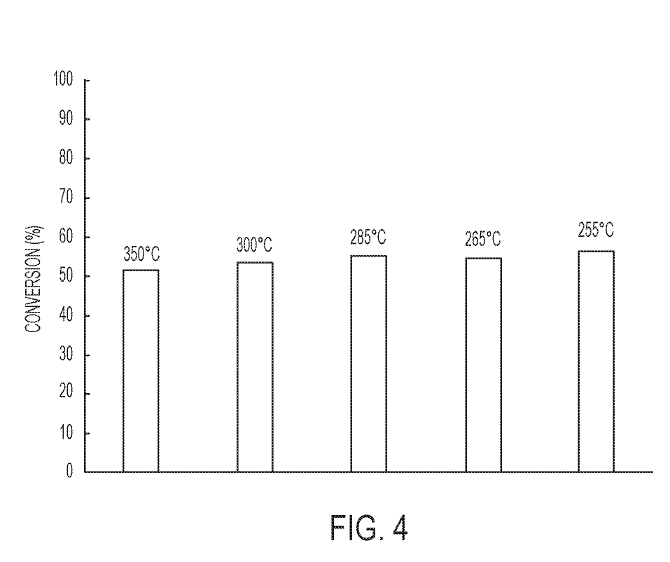

Cobalt catalysts were reduced for 16 hours at different temperatures (255° C., 265° C., 285° C., 300° C., and 350° C.) in the presence of a gas consisting of essentially 100% H₂ at a space-velocity (SV) of 3600 Nm/h/g. The activity of these catalysts was measured as a function of CO in a Fischer-Tropsch process as shown in FIG. 4. For FIG. 4, the reaction conditions Fischer-Tropsch process are as follows: CO:H₂ =1:2 and at a SV=1875 Nm/h/g. As shown in FIG. 4, the CO conversion increases with decreasing reduction temperatures of the catalyst. Table 2 shows the conversion activity for the cobalt catalysts produced and discussed in this example.

TABLE 2

| Reduction | | | | | |
|---|---|---|---|---|---|
| temperature | | | | | |
| (° C.) | X_{CO} % | S_{CH4} | S_{HC+}_{²} | S_{ROH} | S_{CO2} |
| 350 | 51.9 | 6.8 | 58 | 7.2 | 14.5 |
| 325 | 53.7 | 6.6 | 57 | 6.8 | 16.8 |
| 300 | 53.7 | 6.7 | 56 | 7.3 | 15.8 |
| 285 | 55.3 | 6.5 | 56 | 7.3 | 14.5 |
| 275 | 54.4 | 6.5 | 57 | 7.3 | 17.5 |
| 265 | 54.6 | 6.7 | 57 | 7.3 | 15.6 |
| 255 | 56.0 | 6.5 | 56 | 7.1 | 16.2 |

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed is:

1. A method of reducing and activating a cobalt catalyst comprising the step of:
a) contacting an at least partially oxidized cobalt catalyst with a third reducing gas at a temperature from 220° C. to 270° C. for at least 8 hours, wherein the third reducing gas comprises an amount of H₂ sufficient to reduce and activate the cobalt catalyst,
thereby reducing and activating the cobalt catalyst.

2. The method of claim 1, wherein the third reducing gas comprises at least 65% (v/v) of H₂.

3. (canceled)

4. (canceled)

5. The method of claim 1, wherein the third reducing gas comprises at least 95% (v/v) of H₂.

6-9. (canceled)

10. The method of claim 1, wherein the contacting with the third reducing gas is from 8 hours to 25 hours.

11. (canceled)

12. The method of claim 1, wherein the contacting with the third reducing gas is from 25 hours to 70 hours.

13-18. (canceled)

19. The method of claim 1, wherein the temperature in step a) is from 240° C. to 260° C.

20. (canceled)

21. (canceled)

22. The method of claim 1, wherein the method does not comprise contacting the at least partially oxidized cobalt catalyst or the reduced and activated cobalt catalyst with a third reducing gas at a temperature of at least 300° C. for a period of time.

23. (canceled)

24. (canceled)

25. (canceled)

26. The method of claim 1, wherein the method does not comprise an oxidizing step.

27. (canceled)

28. The method of claim 1, wherein the method produces a cobalt catalyst that has at least the same CO conversion activity as compared to a cobalt catalyst that was reduced and activated with an identical third reducing gas at a temperature from 300° C. to 450° C. for the same period of time, wherein the CO conversion rate is measured from a reaction of CO and H₂ at a ratio of 1 to 2, at 5 bar, at 240° C., at a space velocity of 1875 Nm/h/g.

29. (canceled)

30. A method of reducing and activating a cobalt catalyst comprising the step of:
a) contacting an at least partially oxidized cobalt catalyst with a first reducing gas at a temperature from 220° C. to 270° C. for at least 50 hours, and/or
b) contacting an at least partially oxidized cobalt catalyst with a second reducing gas consisting essentially of H₂ at a temperature from 220° C. to 270° C. for at least 8 hours,
thereby reducing and activating the cobalt catalyst.

31. The method of claim 30, wherein the method comprises step a).

32. The method of claim 30, wherein the method comprises step b).

33. (canceled)

34. The method of claim 30, wherein the first reducing gas comprises H₂.

35. The method of claim 30, wherein the first reducing gas comprises H₂ and N₂ at a mole ratio from 2:1 to 1:2.

36. The method of claim 30, wherein the second reducing gas consists of H₂.

37-40. (canceled)

41. The method of claim 30, wherein the temperature in step a) and/or b) is from 240° C. to 260° C.

42. (canceled)

43. (canceled)

44. (canceled)

45. The method of claim 30, wherein the contacting with a first reducing gas is from 60 hours to 80 hours.

46-49. (canceled)

50. The method of claim 30, wherein the contacting with the second reducing gas is from 8 hours to 25 hours.

51. (canceled)

52. The method of claim 30, wherein the method does not comprise contacting the at least partially oxidized cobalt catalyst or the reduced and activated cobalt catalyst with a first reducing gas or a second reducing gas at a temperature of at least 300° C. for a period of time.

53-87. (canceled)

88. A cobalt catalyst produced by any one of claim 1.

89-91. (canceled)
